(19) United States
(12) Patent Application Publication
(10) Pub. No.: US 2007/0170346 A1
(43) Pub. Date: Jul. 26, 2007

(54) Side system for a casting mold and an attaching unit

(75) Inventor: Kari Vappula, Toijala (FI)

Correspondence Address: BUCHANAN, INGERSOLL & ROONEY PC, POST OFFICE BOX 1404, ALEXANDRIA, VA, 22313-1404, US

(73) Assignee: Elematic Oy Ab, Toijala (FI)

(21) Appl. No.: 11/642,870

(22) Filed: Dec. 21, 2006

(30) Foreign Application Priority Data
Jan. 20, 2006 (FI) 20060060

(51) Int. Cl. B28B 7/00

(52) U.S. Cl. 249/139; 249/163; 249/187.1; 425/DIG. 33; 52/396.04; 52/396.08; 425/3; 249/160; 52/402

(57) ABSTRACT

The invention concerns a mold system for manufacturing concrete products, said mold system comprising a mold bed, mold side, magnet unit including a magnet element for attaching the mold side to the mold bed, and a frame surrounding the magnet, whereby there is a space between the upper surface and frame of the magnet element, where the magnet can be lifted from the mold bed, and a lifting element for moving the magnet, and means for attaching the magnet to the mold side. The invention is characterized in that the magnet element is connected to the frame surrounding it by means of a flexible plate being movable with respect to the frame. The invention also concerns said magnet unit.

### FIELD OF THE INVENTION

The present invention concerns a side system for concrete casting molds, said side system comprising a side part to be attached detachably onto the casting bed with one or more magnets. The invention also concerns a magnet unit for attaching the sides to the casting bed.

### PRIOR ART

Detachable sides provided with different attachment solutions are known in the art for casting molds of elements to be cast of concrete. The sides can be positioned in desired places on the casting bed depending on the size and form of the object to be cast.

When wall elements are cast of concrete, the mold to be used is usually a table mold, in other words a tiltable mold equipped with sides. A casting machine moves above the table and batches the concrete mix to the mold. After the concrete is hardened, the table is tipped about a tilting axle provided on one side of the table, into an almost upright position, the side wall of the mold ending up to be the uppermost is removed and the element is lifted away from the table using rings provided on its sides. The position of the upper side must be movable depending on the size of the element to be cast, and for that purpose removable sides can be used. By means of removable and adjustable side parts also door or window openings can be formed to the element in the desired places.

The use of magnets for fastening removable sides of the mold is known in the art, and they are especially suitable for attaching a mold side when attaching them to a flat metal surface of the mold. To provide a strong attachment of the side, strong magnets must be used effecting a bond strength of e.g 15 kN.

Patent EP 1 075 917 B1 discloses a side attaching system where the frame of the unit supporting the magnet comprises a tilting axle, the magnet part being by means of said axle tiltable into a lower position, in which the magnet is attached to the casting bed, and an upper position, in which the magnet is not attached to the casting bed. The side part comprises a holder, onto which the tilting axle of the magnet unit can be supported so that it is movable between the lower and upper position, and the holder has a gripping surface, onto which the upper surface of the magnet can be attached by means of the magnetizing force when the magnet is tilted about its tilting axle to its upper position. A double-acting lever is used for detaching the magnet from the casting bed.

U.S. Pat. No. 6,434,894 discloses a side system, wherein the magnet of the magnet unit is lifted by means of a rodlike lifting element free of the mold to the upper position, where the magnet is engaged to at its upper surface with magnetizing force. U.S. Pat. No. 6,082,701 discloses a side system, wherein the rodlike lifting element is supported to the magnet unit by means of a coil spring. The magnet unit can be either a separate or a fixed part or the side.

The present invention provides a side system and a magnet unit for attaching a side of a casting mold detachably onto a casting bed. The magnet unit comprises preferably a rodlike lifting element for detaching the magnet from the casting bed. The magnet is in contact with the magnet unit by means of a flexible plate. When the magnet is detached from the mold bed, it is resting on said plate. The magnet unit can be either a separate or a fixed part of the side arrangement.

### DESCRIPTION OF THE INVENTION

The mold system in accordance with the invention for manufacturing concrete parts comprises a mold bed, mold side, magnet unit comprising a magnet element for attaching the mold side onto the mold bed, and a frame surrounding the magnet, whereby there is a space between the upper surface of the magnet element and the frame, where the magnet can be lifted from the mold bed; and a lifting element for moving the magnet as well as means for attaching the magnet unit to the mold side. More precisely, the side solution of the concrete casting mold in accordance with the present invention is characterized by what is stated in the characterizing part of claim 1. The magnet unit in accordance with the invention is characterized by what is stated in the characterizing part of claim 5. By means of the present invention, an efficient, simple, less space demanding and steppless magnet attachment for a side system is provided.

The magnet unit is suitable for side systems having different profile forms. Especially suitable it is for a T-formed side systems and a side system, where the magnet unit is attached to the counter part in the side through an oblique bracket of its front surface clinging to the respective groove in the counter part, as described in the Patent EP 1 075 917B1.

### BRIEF DESCRIPTION OF THE DRAWINGS

The invention and its details will be described in more detail in the following, with reference to the enclosed drawings, wherein

FIG. 1 is a cross-sectional view of one magnet unit in accordance with the invention, the magnet being in its upper position (open position) mounted onto a side having a T profile,

FIG. 2 shows the magnet unit of FIG. 1 as a section A-A, when the magnet is in its lower position (closed position), and

FIG. 3 shows one magnet unit in accordance with the invention adapted to one type of a side construction.

### EMBODIMENT OF THE INVENTION

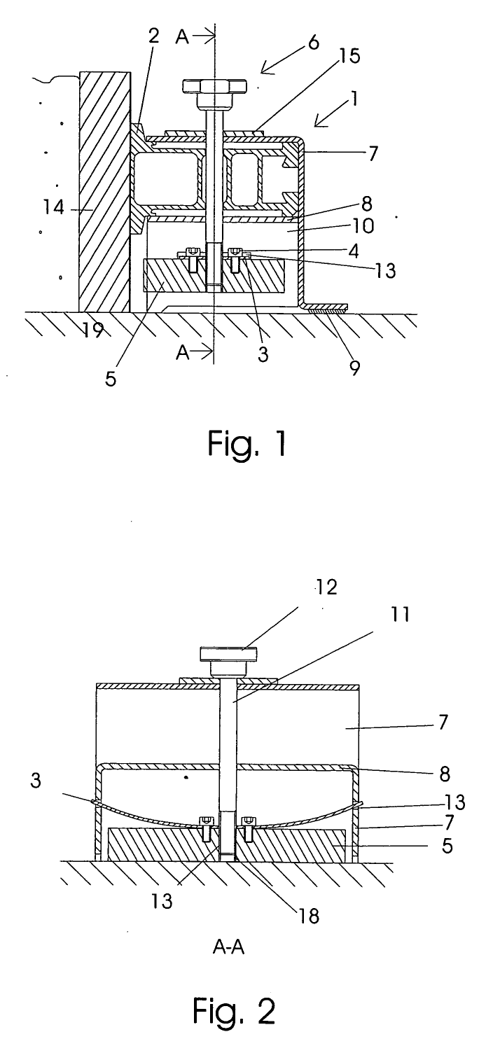

FIG. 1 is a cross-sectional view of one magnet unit in accordance with the invention, the magnet being in its upper position (open position) mounted onto a side having a T profile, and FIG. 2 shows the magnet unit of FIG. 1 as a section A-A, when the magnet is in its lower position (closed position). FIGS. 1 and 2 illustrate also the detaching of the magnet unit from the base and the attaching thereof to the base.

The magnet unit 1 comprises a frame 7, 8 adapted onto the magnet 5 so that it surrounds the magnet on the top and sides apart from the side facing towards the side. Between the magnet 5 and the frame 8 there is a space 10, where the magnet can be lifted, when the magnet unit is not attached to the casting bed. The magnet is coupled to the frame 7 by means of a flexible plate 3, which in this case is a plate spring. The plate 3 is connected to the magnet with screws 4. The magnet is moved by means of a driving pin 6 comprising a rod 11, having at its lower portion screw threads and being attached to the magnet 5 to the screw threads 18 of the magnet, and a head 12. When the magnet is in its upper position (FIG. 1), is supported by the plate 3 being in its basic form and set to the openings 13 on the side of the frame 7. The plate 3 is movable in the openings 13 of the frame 7. When attaching the magnet unit 1 to the casting bed 19, the magnet is lowered to its lower position. The driving pin 6 is hit or turned with a suitable tool downwards so that the magnet 5 is attached to the mold bed 19. Thereby the plate 3 supporting the magnet slides in the side openings 13 of the frame, and the plate 3 bends to an arc.

When opening the magnet unit 1, the driving pin 6 is lifted or turned with a suitable tool against the upper surface of the frame 8 so that the magnet detaches from the casting bed. At the same time the plate 3 supporting the magnet 5 is straightened and lifts the magnet upwards away from its contact area to the casting bed 19. The straightened plate 3 has slid in the openings 13 of the frame 7 outwards and keeps the magnet part 5 up. The plate is in its basic position (open-position of the magnet unit) at a distance from the casting mold and in such a state, that the magnet keeps at its upper position without attaching to the casting bed. The distance of the magnet from the casting bed in the upper position can be adjusted by adjusting the depth of penetration of the driving pin 6 by turning it. In that way the height of the magnet can be adjusted for providing a secure suitability and tightness at each point of the side.

The tightness against the mold surface is provided for the system by the flexibility of the frame when the head 12 of the driving pin 6 presses the cover plate of the frame 8 downwards. At the head 12 of the driving pin 6 in the frame, there is a reinforcement plate 15. The frame 8 of the magnet unit is pulled downwards by the magnet. The back surface 9 of the frame 8 of the magnet unit facing towards the mold bed, said back surface being preferably flexible, in this case a rubber piece separately attached, and the front edge of the side 14 form a counterforce pair. The material of the frame is preferably metal, for example aluminium or steel.

In FIG. 1 the magnet unit is located to the side 14 having a T-profile 2. The magnet unit is set to the profile 13 from one side of the side without driving pin 6. After that the driving pin is pushed through the holes of the frame 7, 8 of the magnet unit and the T profile positioned aligned, and screwed to the thread of the magnet. The length of the driving pin is dimensioned so that when the magnet is in its lower position, the head 12 of the driving pin 6 presses the cover 8, 15 of the frame. The driving pin 6 is preferably equipped with a locking means, f.ex. glue, for locking the driving pin to the magnet. The thus formed locking coupling is opened by screwing out the driving pin form the screw thread of the magnet. In the embodiment of FIG. 1 the magnet unit is attached to the T-profile of the side via driving pin 6 acting also as an actuating device of the magnet 5.

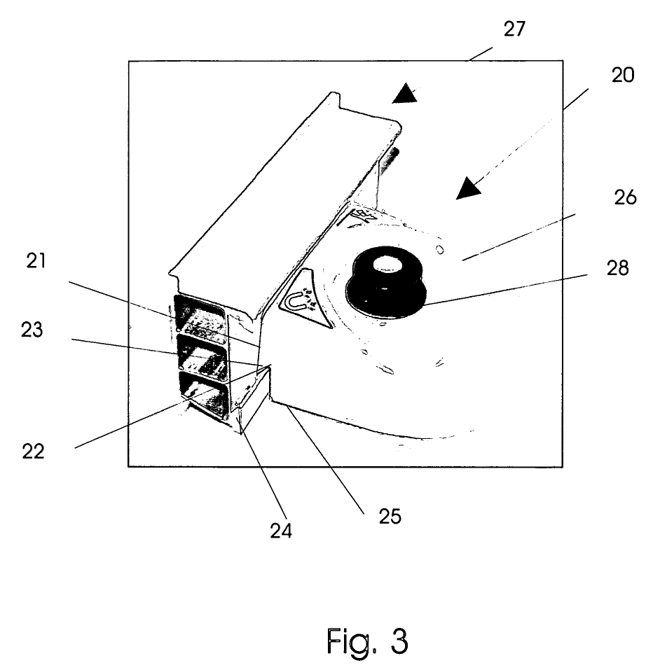

FIG. 3 shows one magnet unit in accordance with the present invention adapted to an other type of a side construction 27. In this embodiment the flexible plate 3 is supported at its ends inside the magnet frame. The tightness comes from the spring of the frame.

Additionally, a flexible washer 28 can be used under the head of the driving pin. In this embodiment the magnet unit 20 comprises an oblique groove, whereby the magnet unit is attached to the side by placing a bracket 23 of the oblique groove 22 on the face surface of the unit to a counter groove 24 provided on the side 27. The front end of the magnet unit is thereby resting on the groove joint, and the lower surface 25 of the front end is loose from the casting bed. The frame of the magnet unit 20 presses the oblique counter-groove 24 downwards pressing the side tightly against the casting bed when the magnet part (not shown in the picture) is down. For the screw attachment there can be threaded holes (not shown in the picture) made onto the face surface and upper surface of the frame 26. The groove-jointed magnet can also be positioned to the abutment of the sides.

In the embodiment of the magnet unit in accordance with FIG. 3, the frame of the magnet unit is set on top of the magnet part and surrounds it also at the side.

The face surface of the magnet unit is manufactured so that it is precisely at an angle of 90° against the casting bed when the magnet is attached to the side, whereby the face surface, due to the wedging effect characteristic of the attaching system, clings to the back surface of the side and keeps the side always vertical. The supporting surfaces of the magnet unit are always formed by the lower surface of its rear part and the side profile, because the lower surface of the front part of the magnet is loose from the casting bed, when the magnet is attached to the side.

The bracket of the magnet unit can have the shape complementary to that of the counter groove in the edge, or it can be an oblique pin or tongue projecting to the oblique hole, sawn groove or corresponding forming the counter groove in the side.

By means of this kind of a groove-jointed side system, a planar pressing force as straight as possible can be exerted to the side. The internal forces of the system make the contact surface of the side and the magnet unit perfectly stiff. The side tends to seal at its front edge the joint between the side and the casting bed and it counteracts the tilting of the side backwards. The attachment can be made quickly and easily, and the point of attachment can be chosen steplessly. By means of this attaching method, the unrestricted positioning of the side can be made possible exactly to the correct place, as well as the releasing of the fixing magnet so that the side does not move.

The system in accordance with the invention can comprise a ready side profile with a running oblique counter groove on its back surface for the magnet. The profile is sold per meters and can be cut case by case. It can be made of steel or for example of extruded light alloy. The side can be formed of the profile as such, or for example equipped with a plywood front surface, as a solid piece or of separate pieces. Due to the guiding counter groove of the side it is easily used for forming different openings using reinforcing pieces, for example window and door openings. Instead of a continuous profile, the side can also have local, narrower oblique counter grooves. This kind of a magnet unit 20 can be located to the abutments of side units, where it in addition to attaching the units to the casting bed, also joints the units with each other. Also a corner joint can be made with suitable fitting elements.

In addition to the groove attachment the magnet unit can be equipped with a screw connection. Preferably both the face surface and the upper surface perpendicular thereto is equipped with threaded holes. Due to the two attachment methods any local adaptations can be made. Attachment and detachment of the magnet unit can also be performed by means of a side robot.

1. A mold system for manufacturing concrete products, said mold system comprising a mold bed, mold side, magnet unit including a magnet element for attaching the mold side to the mold bed and a frame surrounding the magnet, whereby there is a space between the upper surface and the frame of the magnet element, where the magnet can be lifted from the mold bed, and a lifting element for moving the magnet, and means for attaching the magnet unit to the mold side, wherein the magnet element is connected to the frame by means of a flexible plate being movable with respect to the frame.

2. A mold system in accordance with claim 1, wherein the flexible plate is a plate spring.

3. A mold system in accordance with claim 1, wherein the lifting element is also a means for attaching the magnet unit to the mold side.

4. A mold system in accordance with claim 1, wherein the magnet unit comprises at least one face surface equipped with a wedge profile to be adapted to the counter wedge profile of the side for attaching the magnet unit to the mold side.

5. A magnet unit for attaching a side of a concrete mold, whereby the magnet unit comprises a magnet element for attaching the mold side to the mold bed and a frame surrounding the magnet, whereby there is a space between the upper surface of the magnet element and the frame, where the magnet can be lifted from the mold bed, and a lifting element for moving the magnet, wherein the magnet element is connected to the frame by means of a flexible plate being movable with respect to the frame.

6. A magnet unit in accordance with claim 5, wherein the flexible plate is a plate spring.

7. A mold unit in accordance with claim 5, wherein the lifting element is also a means for attaching the magnet unit to the mold side.

8. A side system in accordance with claim 5, wherein the magnet unit comprises at least one face surface equipped with a wedge profile to be adapted to a counter wedge profile in the side for attaching the magnet unit to the mold side.

9. A mold system in accordance with claim 2, wherein the lifting element is also a means for attaching the magnet unit to the mold side.

10. A mold system in accordance with claim 2, wherein the magnet unit comprises at least one face surface equipped with a wedge profile to be adapted to the counter wedge profile of the side for attaching the magnet unit to the mold side.

11. A mold unit in accordance with claim 6, wherein the lifting element is also a means for attaching the magnet unit to the mold side.

12. A side system in accordance with claim 6, wherein the magnet unit comprises at least one face surface equipped with a wedge profile to be adapted to a counter wedge profile in the side for attaching the magnet unit to the mold side.
